(19) United States
(12) Patent Application Publication
(10) Pub. No.: US 2018/0337451 A1
(43) Pub. Date: Nov. 22, 2018

(54) DEVICE AND METHOD FOR AUTOMATICALLY TRACKING BROADCAST SATELLITE USING GLOBAL NAVIGATION SATELLITE SYSTEM (GNSS)

(71) Applicants: Daegu Gyeongbuk Institute of Science and Technology, Dalseong-gun (KR); GNS MOBILANCE CO., LTD., Dalseo-gun (KR)

(72) Inventors: Chi Ho PARK, Dalseong-gun (KR); Nam Hyeok KIM, Dalseong-gun (KR); Joong Hee HAN, Dalseong-gun (KR); Dong Kwon PARK, Dalseo-gu (KR)

(73) Assignees: Daegu Gyeongbuk Institute of Science and Technology, Dalseong-gun (KR); GNS MOBILANCE CO., LTD., Dalseo-gun (KR)

(21) Appl. No.: 15/598,853

(22) Filed: May 18, 2017

(51) Int. Cl. H01Q 3/08; G01S 19/42; H01Q 1/12

(52) U.S. Cl. CPC H01Q 3/08; H04B 7/18523; H01Q 1/125; G01S 19/42

(57) ABSTRACT

The present invention relates to a device and method for automatically tracking a broadcast satellite using a global navigation satellite system (GNSS). The device for automatically tracking a broadcast satellite using a GNSS according to an embodiment of the present invention includes a moving object positioning unit configured to determine current position coordinates of a moving object using a GNSS; a broadcast satellite tracker configured to track a position of a broadcast satellite relative to a current location of the moving object using fixed position coordinates of a broadcast satellite for a channel input to a satellite broadcast receiver of the moving object and the current position coordinates of the moving object; and an antenna driving unit configured to adjust a direction of a satellite broadcast antenna provided in the moving object according to the tracked position of the broadcast satellite.

### BACKGROUND

### 1. Field of the Invention

The present invention relates to a technology for tracking a broadcast satellite, and more particularly, to a device and method for automatically tracking a broadcast satellite using a global navigation satellite system (GNSS).

### 2. Discussion of Related Art

These days, with the development of industrialization, a leisure culture is developing rapidly. Recently, as a camping culture has rapidly spread, the use of camping cars, caravans, leisure cars, food trucks, and the like has increased. With the drastic increase of leisure vehicles, a demand for using satellite broadcast has increased. Here, a satellite broadcast refers to a TV or radio broadcast using a geostationary satellite 36,000 km above the Earth.

A satellite broadcast receives radio waves directly from a space satellite, and hence there is no radio interference according to geographical features so that a picture quality is clear and viewers are allowed to watch various channels related to politics, economies, sports, movies, and music around the world. For example, Korean Broadcasting System (KBS) transmits a satellite broadcast using the Mugunghwa 3 satellite, and Seoul Broadcasting System (SBS) and Munhwa Broadcasting Cooperation (MBC) transmits satellite broadcast using the Mugunghwa 5 satellite. In addition, the satellite broadcast allows viewers to watch various programs that are broadcast 24 hours a day in high-definition (Hi-Fi) stereo sound equivalent to CD sound quality. Such satellite broadcast is also referred to as a Direct-to-Home (DTH) broadcast or a direct broadcasting system (DBS) as the broadcast is broadcast directly to a home without using a repeater.

Since the satellite broadcast transmits radio waves through space, a radio coverage area is wide, it is possible to receive satellite broadcasts of other countries in neighboring countries, and it is possible to provide clear images even in areas in which signal reception is poor. In addition, because a satellite is used as a relay medium for broadcasting, there is an advantage in that it is possible to simultaneously broadcast nationwide in an emergency situation without being damaged by a natural disaster or war.

Current satellite broadcast is mainly used in moving means, such as vehicles or ships in motion. For example, a receiving environment of a satellite broadcast in the moving means may be realized by installing an antenna at the moving means, such as a vehicle, a train, a ship, or the like, and receiving a broadcast while in motion. In this case, a viewer can watch a satellite broadcast using a planar phased array antenna under a dome-shaped structure to avoid air resistance and using a satellite-tracking-system-applied antenna to receive the satellite broadcast regardless of a direction of a moving object.

In addition, a receiving environment of a satellite broadcast in a moving dwelling may be realized by receiving the satellite broadcast in a mobile residence, such as a camping car, a caravan, or the like. In this case, when a place to stay is determined, the satellite broadcast can be viewed by adjusting a parabolic antenna to a direction of a satellite to be watched according to a designated location. At this time, a signal of a desired satellite is input to a satellite broadcast receiver and a blind scan is performed to find the signal.

As an existing method of identifying and tracking a satellite broadcast, a method of confirming whether a satellite broadcast reception antenna is directed toward a satellite to be tracked through satellite downlink frequency spectrum analysis is used. However, this method causes an inconvenience of identifying a unique downlink frequency spectrum through comparison and analysis and has a difficulty in installation and operation.

In addition, an active satellite antenna system which automatically tracks a satellite can track only a single satellite and cannot receive multiple satellite broadcasts at the same time, and hence received broadcast channels are very limited.

### SUMMARY OF THE INVENTION

One objective of the present invention is to provide a device and method for automatically tracking a broadcast satellite using a global navigation satellite system (GNSS), which is capable of identifying a location of a moving object using the GNSS and accurately identifying an orientation and position of a broadcast satellite relative to the moving object.

According to one aspect of the present invention, there is provided a device for automatically tracking a broadcast satellite using a global navigation satellite system (GNSS), the device including: a moving object positioning unit configured to determine current position coordinates of a moving object using a GNSS; a broadcast satellite tracker configured to track a position of a broadcast satellite relative to a current location of the moving object using fixed position coordinates of a broadcast satellite for a channel input to a satellite broadcast receiver of the moving object and the current position coordinates of the moving object; and an antenna driving unit configured to adjust a direction of a satellite broadcast antenna provided in the moving object according to the tracked position of the broadcast satellite.

The broadcast satellite tracker may acquire fixed position coordinates of a broadcast satellite which transmits a satellite broadcast signal of the input channel from a memory which stores fixed position coordinates of broadcast satellites for each broadcast channel.

The broadcast satellite tracker may calculate an azimuth and an elevation of the broadcast satellite relative to the location of the moving object using the current position coordinates of the moving object and the fixed position coordinates of the broadcast satellite.

The broadcast satellite tracker may acquire a line-of-sight (LOS) vector from the current location of the moving object to the position of the broadcast satellite using the current position coordinates of the moving object and the fixed position coordinates of the broadcast satellite, and calculate the azimuth and the elevation using an LOS unit vector which is a unit vector of the LOS vector.

The antenna driving unit may adjust the direction of the satellite broadcast antenna according to the azimuth and elevation so that a satellite broadcast antenna mounted at a predetermined position of the moving object is directed toward the broadcast satellite.

The antenna driving unit minutely adjusts the direction of the satellite broadcast antenna toward a direction in which a satellite broadcast signal with the highest intensity is received among satellite broadcast signals received within a predetermined angular range which is set relative to each of the azimuth and the elevation.

The device may further include a visible satellite monitoring unit configured to monitor a predetermined number or more of visible satellites by checking GNSS signals received through an antenna for a GNSS, wherein the moving object positioning unit determines the position coordinates of the moving object using GNSS signals received from the monitored predetermined number or more of visible satellites.

When the visible satellite monitoring unit fails to monitor the predetermined number or more of visible satellites while repeating the monitoring of the visible satellites a predetermined number of times or more, the broadcast satellite tracker may receive a satellite broadcast signal for the input channel through blind scanning.

The broadcast satellite tracker may check whether the satellite broadcast signal for the input channel is received by comparing information on the input channel and channel information contained in the satellite broadcast signal.

In another general aspect, there is provided a method of automatically tracking a broadcast satellite using a GNSS, the method including: determining current position coordinates of a moving object using a GNSS; tracking a position of a broadcast satellite relative to a current location of the moving object using fixed position coordinates of a broadcast satellite for a channel input to a satellite broadcast receiver of the moving object and the current position coordinates of the moving object; and adjusting a direction of a satellite broadcast antenna provided in the moving object according to the tracked position of the broadcast satellite.

The tracking of the position may include acquiring fixed position coordinates of a broadcast satellite which transmits a satellite broadcast signal of the input channel from a memory which stores fixed position coordinates of broadcast satellites for each broadcast channel.

The tracking of the position may include calculating an azimuth and an elevation of the broadcast satellite relative to the location of the moving object using the current position coordinates of the moving object and the fixed position coordinates of the broadcast satellite.

The tracking of the position may include acquiring a LOS vector from the current location of the moving object to the position of the broadcast satellite using the current position coordinates of the moving object and the fixed position coordinates of the broadcast satellite and calculating the azimuth and the elevation using an LOS unit vector which is an unit vector of the LOS vector.

The adjusting of the direction may include adjusting the direction of the satellite broadcast antenna according toward the azimuth and elevation so that a satellite broadcast antenna mounted at a predetermined position of the moving object is directed toward the broadcast satellite.

The adjusting of the direction may include adjusting minutely the direction of the satellite broadcast antenna toward a direction in which a satellite broadcast signal with the highest intensity is received among satellite broadcast signals received within a predetermined angular range which is set relative to each of the azimuth and the elevation.

The method may further include monitoring a predetermined number or more of visible satellites by checking GNSS signals received through an antenna for a GNSS, wherein the determining of the position includes determining the position coordinates of the moving object using GNSS signals received from the monitored predetermined number or more of visible satellites.

The tracking of the position may include receiving a satellite broadcast signal for the input channel through blind scanning when the predetermined number or more of visible satellites are failed to be monitored while the monitoring of the visible satellites is performed a predetermined number of times or more.

The tracking of the position may include checking whether the satellite broadcast signal for the input channel is received by comparing information on the input channel and channel information contained in the satellite broadcast signal.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a device for automatically tracking a broadcast satellite using a global navigation satellite system (GNSS) according to an embodiment of the present invention;

FIG. 2 is a diagram for describing procedures for determining a position of a moving object using a GNSS according to an embodiment of the present invention;

FIG. 3 is a diagram for describing procedures for calculating an elevation and azimuth between a moving object and a broadcast satellite according to an embodiment of the present invention; and

FIG. 4A and FIG. 4B are flowcharts illustrating a method of automatically tracking a broadcast satellite using a GNSS according to an embodiment of the present invention.

### DETAILED DESCRIPTION OF EXEMPLARY EMBODIMENTS

Advantages and features of the present invention and methods of achieving the same will become apparent by referring to the embodiments described below in detail with reference to the accompanying drawings. However, the present invention is not limited to the embodiments described below and various modifications may be made thereto. The embodiments are merely provided to thoroughly disclose the invention and to convey the aim of the invention to one of ordinary skill in the art. The present invention is defined by the appended claims. The terminology used herein is for the purpose of describing particular embodiments only and is not intended to be limiting of the invention. As used herein, the singular forms “a,” “an,” and “the” are intended to include the plural forms as well unless the context clearly indicates otherwise. It should be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described more fully hereinafter with reference to the accompanying drawings, in which exemplary embodiments of the invention are shown. First, when denoting reference numerals to constitutional elements of respective drawings, it should be noted that the same elements will be denoted by the same reference numerals although they are illustrated in different drawings. Further, a detailed explanation of known related functions and constitutions may be omitted so as to avoid unnecessarily obscuring the subject matter of the present disclosure.

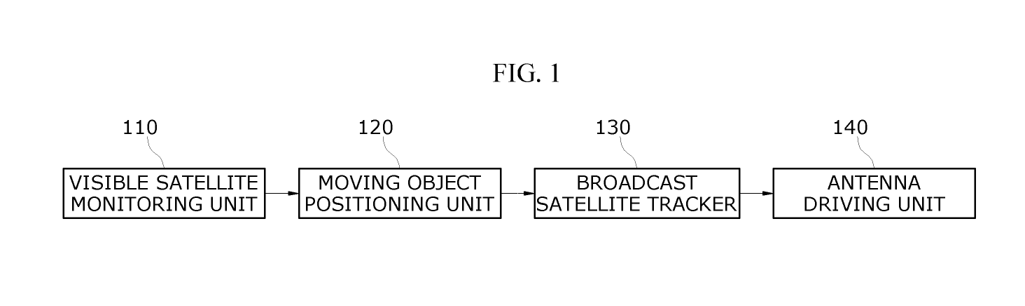

FIG. 1 is a block diagram illustrating a device for automatically tracking a broadcast satellite using a global navigation satellite system (GNSS) according to an embodiment of the present invention.

As shown in FIG. 1, a device 100 for automatically tracking a broadcast satellite using a GNSS according to an embodiment of the present invention includes a visible satellite monitoring unit 110, a moving object positioning unit 120, a broadcast satellite tracker 130, and an antenna driving unit 140.

The visible satellite monitoring unit 110 monitors visible satellites at predetermined intervals and checks whether the number of monitored visible satellites is greater than a predetermined number. In this case, the visible satellites refer to satellites for a GNSS, and the visible satellite monitoring unit 110 may check the number of visible satellites by checking GNSS signals received from the satellites for a GNSS through an antenna for a GNSS. Here, the predetermined number may be altered in advance by an operator or a developer.

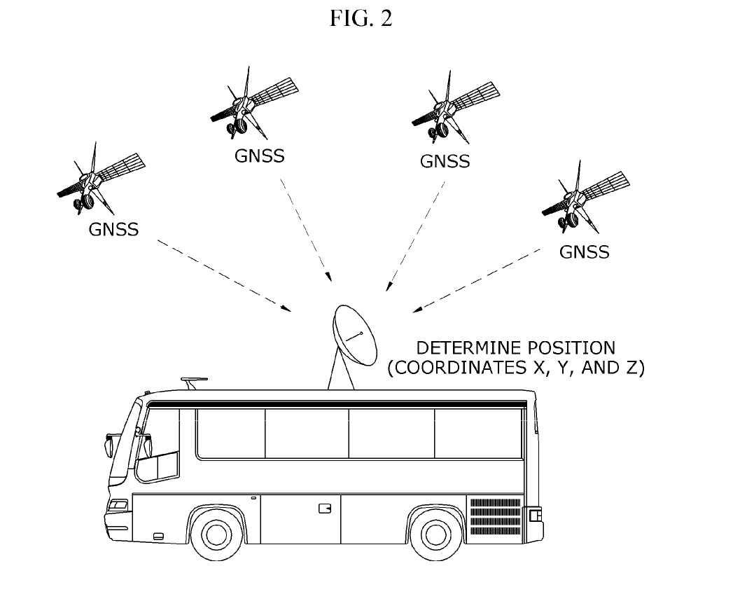

It is preferable to use GNSS signals received from at least four visible satellites, as shown in FIG. 2, to confirm exact position coordinates, and thus the embodiment of the present invention is described under the assumption that the visible satellite monitoring unit 110 checks whether the number of monitored visible satellites is 4 or more.

When the number of monitored visible satellites is less than the predetermined number (4), the visible satellite monitoring unit 110 repeats an operation of monitoring the visible satellites. In this case, when the monitoring of the visible satellites is infinitely repeated, it takes more time than a blind scan and a user may possibly consider the operation as an error. Accordingly, the visible satellite monitoring unit 110 checks whether the predetermined number (4) or more of visible satellites are monitored while repeating the operation of monitoring the visible satellites a number of times that is less than or equal to a predetermined number of repetitions.

When the predetermined number or more of visible satellites are monitored by the visible satellite monitoring unit 110, the moving object positioning unit 120 determines a position of a moving object to receive satellite broadcasting. In this case, the moving object positioning unit 120 may determine current position coordinates (X, Y, and Z) of the moving object (particularly, an antenna of the moving object) using GNSS signals received from the visible satellites through the antenna.

More specifically, as shown in FIG. 2, the moving object positioning unit 120 may calculate distances between each of the visible satellites and the moving object using time information contained in the GNSS signals received from the plurality of visible satellites and time information at which the GNSS signals are received, and may determine the current position coordinates (X, Y, and Z) of the moving object by generating virtual spheres having the calculated distances as their radii. The technique of obtaining position coordinates of a moving object using a GNSS is a well-known technique, and thus a detailed description of the operation will be omitted.

The broadcast satellite tracker 130 tracks an exact orientation and position of the broadcast satellite relative to the moving object using position coordinates of the broadcast satellite and the current position coordinates of the moving object. In this case, the broadcast satellite may be a satellite which transmits a broadcast desired by a viewer of the moving object.

When the viewer of the moving object selects a desired broadcast channel, the broadcast satellite tracker 130 tracks an exact orientation and position of a broadcast satellite which transmits a satellite broadcast signal of the selected broadcast channel. Here, since the broadcast satellite is a satellite at a fixed point above the equator, the position coordinates thereof do not change. Thus, according to an embodiment of the present invention, fixed position coordinates (Pn(Xn, Yn, and Zn), wherein n denotes the number of broadcast satellites stored and is a natural number greater than or equal to 1) of each of the plurality of broadcast satellites may be previously stored as a database in a storage unit (not shown).

The broadcast satellite tracker 130 acquires the fixed position coordinates of the broadcast satellite that transmits the satellite broadcast of the channel selected by the user from the storage unit to track the exact orientation and position of the broadcast satellite relative to the moving object. In this case, the broadcast satellite tracker 130 may receive information on the channel selected by the user from a satellite broadcast receiver provided at a specific position of the moving object.

The broadcast satellite tracker 130 acquires a line-of-sight (LOS) vector from the moving object (i.e., an antenna) to the broadcast satellite using the acquired fixed position coordinates of the broadcast satellite and the current position coordinates of the moving object which have been determined by the moving object positioning unit 120.

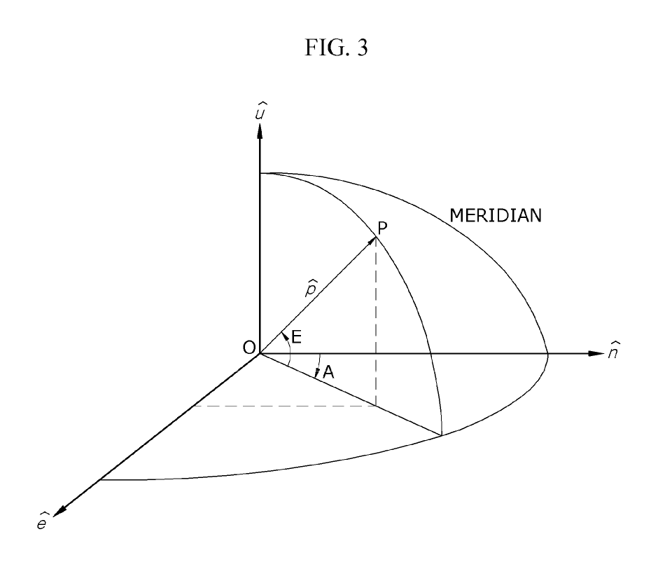

For example, with reference to FIG. 3, the LOS vector may be acquired by subtracting fixed position coordinates (P(X, Y, and Z)) of the broadcast satellite from current position coordinates (O(X, Y, and Z)) of the moving object. In this case, an LOS unit vector \hat{ρ} may be acquired by dividing the LOS vector by a size of the LOS vector, and the formula thereof may be the following Equation 1.

$$\hat{ρ} = \frac{{r}^{sat} - {r}_{rcv}}{‖ {r}^{sat} - {r}_{rcv} ‖} \qquad [ Equation 1 ]$$

Here, r^{sat} represents a fixed position coordinate vector of the broadcast satellite and rᵣₑᵥ represents a current position coordinate vector of the moving object.

The broadcast satellite tracker 130 may calculate an azimuth and elevation of the broadcast satellite relative to the moving object using the current position coordinates of the moving object, the position coordinates of the broadcast satellite, and the LOS unit vector \hat{ρ}. In this case, the broadcast satellite tracker 130 may calculate the azimuth (A) and the elevation (E) using Equations 2 and 3.

$$\begin{matrix}\hat{ρ} \cdot \hat{e} = cos E sin A \\ \hat{ρ} \cdot \hat{n} = cos E cos A \\ \hat{ρ} \cdot \hat{u} = sin E & [ Equation 2 ] \\ E = arc sin ( \hat{ρ} \cdot \hat{u} ) \\ A = arc tan ( \frac{\hat{ρ} \cdot \hat{e}}{\hat{ρ} \cdot \hat{n}} ) & [ Equation 3 ]\end{matrix}$$

Here, ê denotes an LOS unit vector from the moving object to the broadcast satellite on an X axis, \hat{n} denotes an LOS unit vector from the moving object to the broadcast satellite on a Y axis, and û denotes an LOS unit vector from the moving object to the broadcast satellite on a Z axis.

The broadcast satellite tracker 130 may track the exact orientation and position of the broadcast satellite using the current position coordinates of the moving object, the position coordinates of the broadcast satellite, and the azimuth (A) and elevation (E) of the broadcast satellite relative to the moving object.

Meanwhile, in a case in which the visible satellite monitoring unit 110 confirms that the monitored number of visible satellites is less than the predetermined number while repeating the operation of monitoring the visible satellites the predetermined number of times or more, it is determined that a surrounding environment is poor, and the broadcast satellite tracker 130 performs an operation of blind scanning for a broadcast satellite.

In this case, the blind scan is a technique of searching for a satellite signal (frequency) for a channel input to a satellite broadcast receiver, checking whether the search result corresponds to a desired broadcast satellite on the basis of a frequency, and receiving a satellite broadcast signal from the desired broadcast satellite. The blind scan technique is a well-known technique, in satellite broadcast technology, and thus a detailed description thereof will be omitted.

In addition, the broadcast satellite tracker 130 analyzes a satellite broadcast signal received through a satellite broadcast antenna and checks whether the broadcast satellite transmits a broadcast of a channel to be viewed at the moving object, i.e., the broadcast channel selected by the user. The broadcast satellite tracker 130 may compare information on the broadcast channel selected by the user with channel information contained in the satellite broadcast signal received from the broadcast satellite and check whether the antenna is directed toward a broadcast satellite to be viewed at the moving object.

When the comparison result indicates that the information on the broadcast channel selected does not match the channel information of the received satellite broadcast signal, the moving object positioning unit 120 re-checks the position of the moving object.

The antenna driving unit 140 adjusts a direction of the antenna by taking into consideration the orientation and position of the broadcast satellite tracked by the broadcast satellite tracker 130 so that the satellite broadcast antenna through which the satellite broadcast signal is received from the broadcast satellite can be directed toward the desired broadcast satellite. To this end, the antenna driving unit 140 may include a motor for adjusting an elevation and azimuth of the antenna.

Also, the antenna driving unit 140 minutely adjusts the direction of the antenna while measuring an intensity of the satellite broadcast signal received from the broadcast satellite through the antenna. For example, the antenna driving unit 140 receives the satellite broadcast signal by adjusting the direction of the satellite broadcast antenna within a predetermined angular range relative to the azimuth and elevation calculated by the broadcast satellite tracker 130. Here, the predetermined angular range may be set or altered in advance by an operator or a developer. In addition, a predetermined angle (a first angle) relative to the azimuth and a predetermined angle (a second angle) relative to the elevation may be the same as or different from each other.

The antenna driving unit 140 may minutely adjust the direction of the satellite broadcast antenna to a direction in which a signal with the highest intensity is received among a plurality of signals received within the predetermined angular range.

Similarly, in a case in which the broadcast satellite tracker 130 tracks the broadcast satellite through blind scanning, the antenna driving unit 140 may adjust the direction of the antenna while measuring the intensity of the satellite broadcast signal received from the broadcast satellite.

Ultimately, when the antenna is directed toward the broadcast satellite of the channel to be viewed by the user and the satellite broadcast signal is received, the received satellite broadcast signal may be transmitted to the satellite broadcast receiver through a low noise block (LNB) downconverter, and the satellite broadcast receiver may output the satellite broadcast signal through a monitor.

As described above, according to the embodiment of the present invention, an azimuth and elevation of a broadcast satellite relative to a moving object are calculated using current position coordinates of the moving object and unique position coordinates of a broadcast satellite for a channel to be viewed, and an antenna is driven to be directed toward the calculated azimuth and elevation so that it is possible to automatically track the satellite broadcast even in situations in which the moving object is stationary or moving and there are no difficulties in operation, installation, and signal analysis.

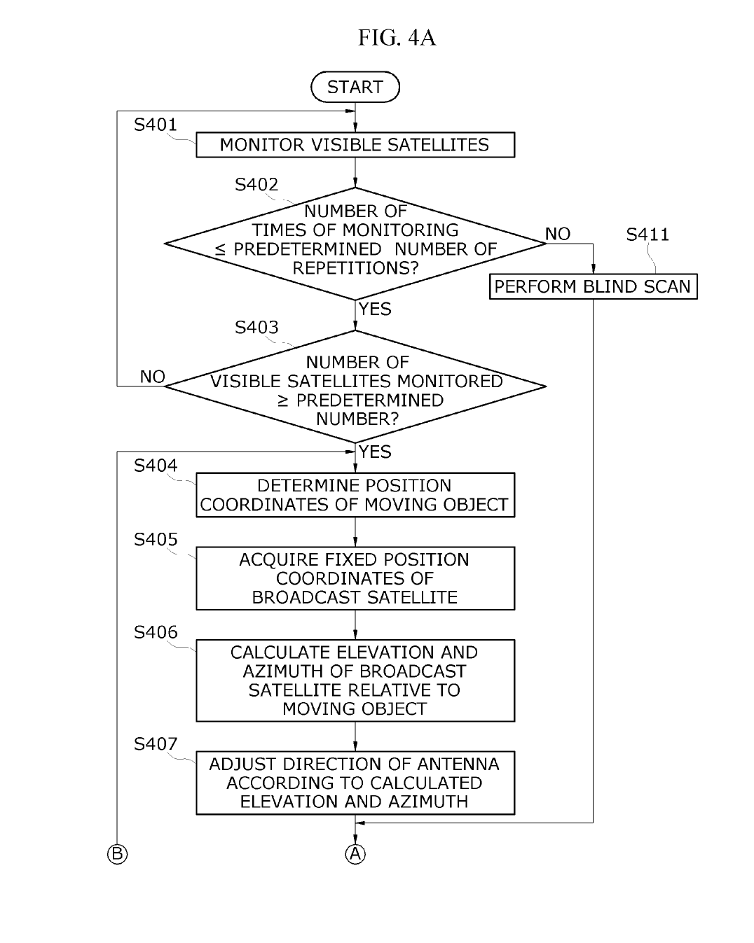

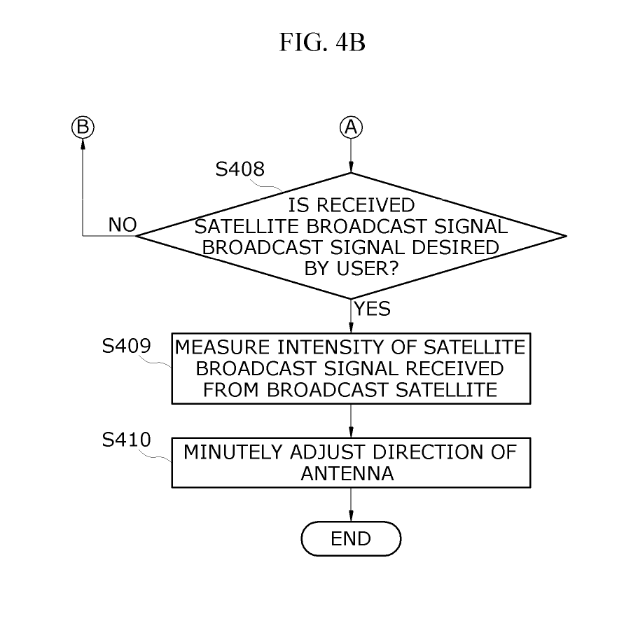

FIG. 4A and FIG. 4B are flowcharts illustrating a method of automatically identifying and estimating a satellite using a GNSS.

Unless particularly stated otherwise herein, it is assumed that the method of FIG. 4A and FIG. 4B is performed by the device 100 for automatically tracking a broadcast satellite using GNSS according to the embodiment of the present invention.

First, the device 100 monitors visible satellites (S401). In this case, the visible satellites refer to satellites for a GNSS, and the device 100 may monitor the visible satellites by checking GNSS signals received from the satellites for a GNSS through an antenna for a GNSS.

The device 100 checks whether a predetermined number or more of visible satellites are monitored while repeating the operation of monitoring the visible satellites a number of times that is less than or equal to a predetermined number of repetitions (S402) and (S403). In this case, the predetermined number of repetitions and the predetermined number of visible satellites may be set or altered in advance by an operator or a developer. More specifically, the device 100 monitors the visible satellites at predetermined intervals and checks whether the number of monitored visible satellites is greater than or equal to the predetermined number. It is preferable to use GNSS signals received from at least four visible satellites, as shown in FIG. 2, to check exact current position coordinates of a moving object, and thus the embodiment of the present invention is described under the assumption that the device 100 checks whether the number of monitored visible satellites is 4 or more.

When the number of monitored visible satellites is less than the predetermined number (4), the device 100 repeats the operation of monitoring the visible satellites. In this case, when the monitoring of the visible satellites is repeated infinitely, it takes more time than a blind scan and a user may possibly consider the operation as an error. Accordingly, the device 100 checks whether the predetermined number (4) or more of visible satellites are monitored while repeating the operation of monitoring the visible satellites a number of times that is less than or equal to the predetermined number of repetitions.

When the predetermined number or more of visible satellites are monitored, the device 100 determines the current position of the moving object to receive a satellite broadcast (S404). At this time, the device 100 may determine current position coordinates (X, Y, and Z) of the moving object (particularly, an antenna of the moving object) using the GNSS signals received from the visible satellites through the antenna.

More specifically, the device 100 may calculate distances between each of the visible satellites and the moving object using time information contained in the GNSS signals received from the plurality of visible satellites and time information at which the GNSS signals are received, and may determine the current position coordinates (X, Y, and Z) of the moving object by generating virtual spheres having the calculated distances as their radii. The technique of obtaining position coordinates of a moving object using a GNSS is a well-known technique, and thus a detailed description of the operation will be omitted.

The device 100 acquires fixed position coordinates of a broadcast satellite that transmits a satellite broadcast of a channel selected by the user from the moving object (S405). In this case, the device 100 may receive information on the channel selected by the user from a satellite broadcast receiver provided at a specific position of the moving object.

Since the broadcast satellite is a satellite at a fixed point above the equator, the position coordinates thereof do not change. Thus, according to an embodiment of the present invention, the fixed position coordinates (Pn(Xn, Yn, and Zn), wherein n denotes the number of broadcast satellites stored and is a natural number that is greater than or equal to 1) of each of the plurality of broadcast satellites may be previously stored as a database in a separate memory.

The device 100 calculates an elevation and azimuth of the broadcast satellite relative to the moving object using the position coordinates of the broadcast satellite and the current position coordinates of the moving object (S406).

More specifically, the device 100 obtains an LOS vector from the moving object (an antenna) to the broadcast satellite using the current position coordinates of the moving object determined in operation S404 and the fixed position coordinates of the broadcast satellite obtained in operation S405. For example, with reference to FIG. 3, the LOS vector may be acquired by subtracting the fixed position coordinates (P(X, Y, and Z)) of the broadcast satellite from the current position coordinates (O(X, Y, and Z)) of the moving object. In this case, the LOS unit vector P may be obtained by dividing the LOS vector by a size of the LOS vector, and the formula thereof may be the above-described Equation 1.

The device 100 may calculate the azimuth and elevation of the broadcast satellite relative to the moving object using the current position coordinates of the moving object, the position coordinates of the broadcast satellite, and the LOS unit vector \hat{ρ}. In this case, the device 100 may calculate the azimuth (A) and the elevation (E) using Equations 2 and 3.

The device 100 may acquire the exact orientation and position of the broadcast satellite using the current position coordinates of the moving object, the position coordinates of the broadcast satellite, and the azimuth and elevation of the broadcast satellite relative to the moving object which are calculated through the above procedures.

The device 100 adjusts a direction of the antenna using the azimuth and elevation of the broadcast satellite calculated in operation S406 so that the satellite broadcast antenna through which a satellite broadcast signal is received from a broadcast satellite can be directed toward the desired broadcast satellite (S407). To this end, the device 100 may control a motor for adjusting an elevation and azimuth of the antenna.

The device 100 analyzes the satellite broadcast signal received through the satellite broadcast antenna and checks whether the broadcast satellite transmits a broadcast of a channel to be viewed at the moving object, i.e., the channel selected by the user (S408). The device 100 may compare information on a broadcast channel selected by the moving object with channel information contained in the satellite broadcast signal received from the broadcast satellite and check whether the antenna is directed toward the broadcast satellite to be viewed at the moving object.

When the checking result of operation S408 indicates that the antenna is directed toward the desired broadcast satellite, the device 100 minutely adjusts the direction of the antenna while measuring an intensity of the satellite broadcast signal received from the broadcast satellite through the antenna (S409) and (S410). For example, the device 100 receives the satellite broadcast signal by adjusting the direction of the satellite broadcast antenna within a predetermined angular range relative to the azimuth and elevation calculated in operation S406. Here, the predetermined angular range may be set or altered in advance by an operator or a developer. In addition, a predetermined angle (the first angle) relative to the azimuth and a predetermined angle (the second angle) relative to the elevation may be the same as or different from each other.

For example, the device 100 may ultimately determine the direction and position of the satellite broadcast antenna to be a direction in which a signal with the highest intensity is received among a plurality of signals received within the predetermined angular range.

Meanwhile, when the checking result of operation S402 indicates that the number of times of monitoring the visible satellites exceeds the predetermined number of repetitions, it is determined that a surrounding environment is poor, and the device 100 performs an operation of blind scanning for the broadcast satellite (S411).

In this case, the blind scan is a technique of searching for a satellite signal (a frequency) for a channel input to the satellite broadcast receiver, checking whether the search result corresponds to a desired broadcast satellite on the basis of a frequency, and receiving a satellite broadcast signal from the desired broadcast satellite. The blind scan technique is a well-known technique in the satellite broadcast technology, and thus a detailed description of the operation will be omitted.

Similarly, in a case in which the broadcast satellite is tracked through blind scanning, the device 100 may check whether the antenna is directed toward a broadcast satellite which transmits a broadcast of the channel selected by the user.

Ultimately, when the direction of the antenna is minutely adjusted and the satellite broadcast signal of the channel to be viewed by the user is received, the received satellite broadcast signal may be transmitted to the satellite broadcast receiver through an LNB downconverter, and the satellite broadcast receiver may output the satellite broadcast signal through a monitor.

As described above, according to the embodiment of the present invention, an azimuth and elevation of a broadcast satellite relative to a moving object are calculated using current position coordinates of the moving object and unique position coordinates of a broadcast satellite for a channel to be viewed, and an antenna is driven to be directed toward the calculated azimuth and elevation so that it is possible to automatically track the satellite broadcast even in situations in which the moving object is stationary or moving and there are no difficulties in operation, installation, and signal analysis.

It will be understood by those skilled in the art that the invention may be performed in other concrete forms without changing the technological scope and essential features. Therefore, the above-described embodiments should be considered in a descriptive sense only and not for purposes of limitation. The scope of the present invention is defined not by the detailed description but by the appended claims, and encompasses all modifications and alterations derived from meanings, the scope and equivalents of the appended claims.

### REFERENCE NUMERALS

100: DEVICE FOR AUTOMATICALLY TRACKING BROADCAST SATELLITE
110: VISIBLE SATELLITE MONITORING UNIT
120: MOVING OBJECT TRACKER
130: BROADCAST SATELLITE TRACKER
140: ANTENNA DRIVING UNIT

What is claimed is:

1. A device for automatically tracking a broadcast satellite using a global navigation satellite system (GNSS), the device comprising:
a moving object positioning unit configured to determine current position coordinates of a moving object using a GNSS;
a broadcast satellite tracker configured to track a position of a broadcast satellite relative to a current location of the moving object using fixed position coordinates of a broadcast satellite for a channel input to a satellite broadcast receiver of the moving object and the current position coordinates of the moving object; and
an antenna driving unit configured to adjust a direction of a satellite broadcast antenna provided in the moving object according to the tracked position of the broadcast satellite.

2. The device of claim 1, wherein the broadcast satellite tracker acquires fixed position coordinates of a broadcast satellite which transmits a satellite broadcast signal of the input channel from a memory which stores fixed position coordinates of broadcast satellites for each broadcast channel.

3. The device of claim 1, wherein the broadcast satellite tracker calculates an azimuth and an elevation of the broadcast satellite relative to the location of the moving object using the current position coordinates of the moving object and the fixed position coordinates of the broadcast satellite.

4. The device of claim 3, wherein the broadcast satellite tracker acquires a line-of-sight (LOS) vector from the current location of the moving object to the position of the broadcast satellite using the current position coordinates of the moving object and the fixed position coordinates of the broadcast satellite, and calculates the azimuth and the elevation using an LOS unit vector which is a unit vector of the LOS vector.

5. The device of claim 3, wherein the antenna driving unit adjusts the direction of the satellite broadcast antenna according to the azimuth and elevation so that a satellite broadcast antenna mounted at a predetermined position of the moving object is directed toward the broadcast satellite.

6. The device of claim 5, wherein the antenna driving unit minutely adjusts the direction of the satellite broadcast antenna toward a direction in which a satellite broadcast signal with the highest intensity is received among satellite broadcast signals received within a predetermined angular range which is set relative to each of the azimuth and the elevation.

7. The device of claim 1, further comprising:
a visible satellite monitoring unit configured to monitor a predetermined number or more of visible satellites by checking GNSS signals received through an antenna for a GNSS,
wherein the moving object positioning unit determines the position coordinates of the moving object using GNSS signals received from the monitored predetermined number or more of visible satellites.

8. The device of claim 7, wherein when the visible satellite monitoring unit fails to monitor the predetermined number or more of visible satellites while repeating the monitoring of the visible satellites a predetermined number of times or more, the broadcast satellite tracker receives a satellite broadcast signal for the input channel through blind scanning.

9. The device of claim 8, wherein the broadcast satellite tracker checks whether the satellite broadcast signal for the input channel is received by comparing information on the input channel and channel information contained in the satellite broadcast signal.

10. A method of automatically tracking a broadcast satellite using a global navigation satellite system (GNSS), the method comprising:
determining current position coordinates of a moving object using a GNSS;
tracking a position of a broadcast satellite relative to a current location of the moving object using fixed position coordinates of a broadcast satellite for a channel input to a satellite broadcast receiver of the moving object and the current position coordinates of the moving object; and
adjusting a direction of a satellite broadcast antenna provided in the moving object according to the tracked position of the broadcast satellite.

11. The method of claim 10, wherein the tracking of the position includes acquiring fixed position coordinates of a broadcast satellite which transmits a satellite broadcast signal of the input channel from a memory which stores fixed position coordinates of broadcast satellites for each broadcast channel.

12. The method of claim 10, wherein the tracking of the position includes calculating an azimuth and an elevation of the broadcast satellite relative to the location of the moving object using the current position coordinates of the moving object and the fixed position coordinates of the broadcast satellite.

13. The method of claim 12, wherein the tracking of the position includes acquiring a line-of-sight (LOS) vector from the current location of the moving object to the position of the broadcast satellite using the current position coordinates of the moving object and the fixed position coordinates of the broadcast satellite and calculating the azimuth and the elevation using an LOS unit vector which is an unit vector of the LOS vector.

14. The method of claim 12, wherein the adjusting of the direction includes adjusting the direction of the satellite broadcast antenna according toward the azimuth and elevation so that a satellite broadcast antenna mounted at a predetermined position of the moving object is directed toward the broadcast satellite.

15. The method of claim 14, wherein the adjusting of the direction includes adjusting minutely the direction of the satellite broadcast antenna toward a direction in which a satellite broadcast signal with the highest intensity is received among satellite broadcast signals received within a predetermined angular range which is set relative to each of the azimuth and the elevation.

16. The method of claim 10, further comprising:
monitoring a predetermined number or more of visible satellites by checking GNSS signals received through an antenna for a GNSS,
wherein the determining of the position includes determining the position coordinates of the moving object using GNSS signals received from the monitored predetermined number or more of visible satellites.

17. The method of claim 16, wherein the tracking of the position includes receiving a satellite broadcast signal for the input channel through blind scanning when the predetermined number or more of visible satellites are failed to be monitored while the monitoring of the visible satellites is performed a predetermined number of times or more.

18. The method of claim 17, wherein the tracking of the position includes checking whether the satellite broadcast signal for the input channel is received by comparing information on the input channel and channel information contained in the satellite broadcast signal.
